(19) United States
(12) Patent Application Publication
(10) Pub. No.: US 2013/0303810 A1
(43) Pub. Date: Nov. 14, 2013

(54) REACTOR AND METHOD FOR THE AT LEAST PARTIAL DECOMPOSITION, IN PARTICULAR DEPOLYMERIZATION, AND/OR PURIFICATION OF PLASTIC MATERIAL

(71) Applicant: Adam Handerek, Bielsko-Biala (PL)

(72) Inventor: Adam Handerek, Bielsko-Biala (PL)

(73) Assignee: Hartwig SCHLUETER, Kaufungen (DE)

(21) Appl. No.: 13/883,022

(22) PCT Filed: Nov. 1, 2011
(86) PCT No.: PCT/DE2011/001975

§ 371 Date: Jul. 9, 2013

(30) Foreign Application Priority Data
Nov. 2, 2010 (DE) 10 2010 050 152.2

(51) Int. Cl. B01J 8/00

(52) U.S. Cl. CPC B01J 8/008
USPC 585/241; 422/198; 422/199

(57) ABSTRACT

The invention relates to a reactor for gasifying and/or purifying, in particular depolymerizing, plastic material (12), comprising a reactor vessel (14) for holding the plastic material (12) and a heater (18) for heating the plastic material (12) in the reactor vessel (14), the reactor vessel being at least partially filled with a metal bath (26). According to the invention, a deceleration device (24, 32) is provided in an interior (22) of the reactor vessel (14) to decelerate a flow of liquefied plastic material (12) in the reactor vessel (14), said deceleration device (24, 32) having a plurality of elements (25) that are movably arranged in the interior (22).

The invention relates to a reactor for gasifying and/or purifying plastic material with (a) a reactor vessel for holding the plastic material and (b) a heater for heating the plastic material in the reactor vessel, (c) the reactor vessel being at least partially filled with a metal bath. According to a second aspect the invention relates to a method for the at least partially decomposition, in particular depolymerization, and/or purification of plastic material.

Used plastic items are currently recycled mostly by processing them to create products for which the quality of the plastic material is not so important, for example benches or poles. However, using them in this way does not allow for the disposal of the immense amounts of plastic waste, so that a large proportion of the plastic waste is used as fuel, which is undesirable from an environmental protection point of view.

A device for the treatment of waste is described in U.S. Pat. No. 5,436,210 wherein the waste is introduced from below into a bath of liquid metal. The waste decomposes and leaves the bath in the form of a liquid or a gas.

A device is described in EP 1 840 191 A1 for the gasification of biomass. A reactor of this sort is generally not suitable for gasifying or purifying plastic material, as the underlying chemical processes are different.

A reactor according to the preamble is described in EP 2 161 299. In this reactor, plastic material waste is introduced into a metal bath, by means of which they are heated and depolymerized. The disadvantage of a reactor of this sort is that a high depolymerization rate requires very large reactors.

A method is described in DE 10 2007 059 967 for carrying out chemical reactions by means of an inductively heated heating medium. Unlike with a reactor from the present invention, the method described relates to a synthesis, not a depolymerization.

A reactor for the pyrolysis of waste materials is described in DE 23 28 545, wherein balls are added to the waste materials. The balls are heated by means of an induction heater. This reactor contains no metal bath.

A depolymerization reactor is described in WO 2004/106 277 A1 wherein balls are also provided for heating by an inductive heater. This reactor does not comprise a metal bath either.

A particular challenge for the recycling of plastic material features contaminants. It must be guaranteed that any contaminants, such as sand, organic residues or similar, do not affect the recycling process.

The invention aims to reduce the disadvantages in the prior art.

The invention solves the problem by means of a reactor which comprises a deceleration device arranged in an interior of the reactor vessel to decelerate a flow of liquefied plastic material in the reactor vessel, said deceleration device having a plurality of elements that are movably arranged in the interior.

An advantage of the invention is that the deceleration device can be designed in such a way that it forces the plastic material on a meandering path. The plastic material then covers a long path, due to the presence of the deceleration device in the reactor vessel, meaning that a large part of it reacts chemically. As a result of the plurality of elements that are movably arranged in the interior, the plastic material, which has been heated by the heater and thereby liquefied, must therefore follow a long path past the elements in order to pass through the reactor. This leads to a high yield of decomposition products.

A further advantage is that the elements are freely movably arranged and can therefore be easily moved relative to each other. Contaminants of the plastic material can indeed be deposited on the elements, but any deposits are quickly removed by constant collisions of the elements and can leave the reactor from above.

In addition, it is advantageous that the elements can form reactive surfaces which can accelerate the chemical reaction in the reactor. For this purpose the elements may comprise a coating with a catalyst.

Within the scope of the above description, the term reactor may be understood to mean in particular a thermocatalytic depolymerization reactor. This refers to a reactor that is designed to thermally and/or catalytically depolymerize supplied polymers and/or to decompose them into materials with a low melting or boiling point. However, the reactor can also be designed for the purification of plastic material. The temperature in the reactor is then preferably selected in such a way that the contaminant is decomposed, but the plastic material remains uninfluenced.

The term heater should be understood to mean every device that is intended to supply heat energy to the plastic material inside the reactor vessel. It preferably refers to an inductive heater which generates heat inductively, at least in parts of the reactor vessel and/or in components arranged in the interior of the reactor vessel. This has the advantage that parts located a long way radially into the reactor vessel can also be heated efficiently.

The term deceleration device should be understood particularly to mean a collection of partial components, called elements, which are also at least arranged in the reactor vessel, causing a flow of liquefied plastic material moving from an entry point to an exit point to be decelerated. The term plurality of movable elements should be understood particularly to mean that at least 1000, in particular 10,000, of these elements are available.

The property that the elements in the interior are movably arranged may be understood particularly to mean that the elements can move freely in at least one degree of freedom. It is especially favorable if the elements can move freely in two, three or more degrees of freedom. However, this does not exclude the fact that the elements may be prevented from reaching every point in the interior. In particular, restraint devices can be provided which prevent the elements from moving freely at every point in the interior of the reactor vessel. It is also possible that the individual elements are fixed, for example by means of flexible fixing elements. However, this is complex.

The term elements refers particularly to loose elements. This means that the elements do not interlock with each other, rather they can slide across each other. For this purpose the elements are particularly designed to be convex, for example ball-like. This should be understood particularly to mean that a radius of a conceived enclosing sphere that has a minimal diameter and that completely surrounds the element, that is at most twice as large as the radius of the largest conceived inscribes sphere, which is the biggest conceived sphere that can be inscribed into the element.

According to a preferred embodiment, the elements are made predominantly from ferromagnetic material. If the heater is an inductive heater, the elements heat up, thus allowing a particularly intensive chemical reaction can occur on the surface of the elements.

This metal bath preferably has a melting point under 150° C. However, it is also possible to select a metal bath whose melting point is under 250° C. or even just under 300° C.

The reactor preferably comprises a supply device for supplying plastic material. This supply device is preferably arranged close to the base of the reactor vessel. It may comprise an extruder by means of which the plastic material can be plasticized. It is favorable if the extruder is arranged in such a way that it drains the plastic material close to the base of the reactor vessel into the reactor vessel.

It is favorable if the reactor comprises a condenser by means of which gases leaving the reactor vessel can be condensed. Gases of this sort are products of the decomposition of the plastic material, for example. It is favorable if the reactor vessel comprises polyolefin, which is introduced into the reactor vessel from below via the dosing device, for example. Should the polyolefin decompose, an oil-like substance is formed which can be burnt to create heat or used for synthesis purposes.

According to a preferred embodiment, the reactor comprises at least one holding device for the prevention of the floatation of the balls. As a general rule, metal baths with a melting point under 300° C. have a density of more than 8 grams per cubic centimeter. Should steel elements be used, as in a preferred embodiment, they experience a lift in the metal bath. The holding devices are provided to prevent the elements from rising to the surface of the metal bath. In order to allow gases resulting from the reaction to leave the reactor vessel quickly, the restraint device preferably comprises a plurality of recesses, which are arranged in such a way that the elements are restrained, but the gas can flow freely through.

The at least one restraint device is preferably connected to at least one movement device to move the restraint device up and down. This allows the restraint device and the elements lying on the restraint device to be moved so that the elements come into contact with each other and any deposits on the elements are removed.

The movement device may comprise, for example, one or several rods that run along a longitudinal axis of the reactor vessel.

It is particularly preferable if the restraint device is connected to a motor, so that the restraint device can be moved in an oscillating movement. An oscillating movement removes contaminants from the elements and leads to the removal of gas bubbles, thereby accelerating the release of occurring gases.

A particularly efficient movement of the elements is achieved if a plurality of restraint devices is provided, which can be automatically moved independently from each other in an oscillating movement, in particular along the longitudinal axis of the reactor vessel.

In particular, if the reactor vessel has a plastic material input device on its base, the viscosity of the plastic material changes to such an extent that the viscosity (toughness) reduces as it moves upwards. In order to ensure that a deceleration effect is nevertheless achieved in the elements, which essentially remains the same, an average radius of the elements that rises with an increase in height is provided, according to a preferred embodiment. The term radius of the elements should be understood to mean the radius of an ideal ball which is equal in volume. Unless the elements do not all have the same radius, the corresponding radius should always be understood to mean the median of the radii.

It is favorable if the plastic material is at least predominantly made from polyolefin that sets at 23° C. It is also possible to use other plastics that do not contain halogens. However, it is possible to use a limited percentage, for example less than 10%, of plastics that contain halogens.

With the aid of a drawing an embodiment of the present invention will be explained in more detail. What is shown is:

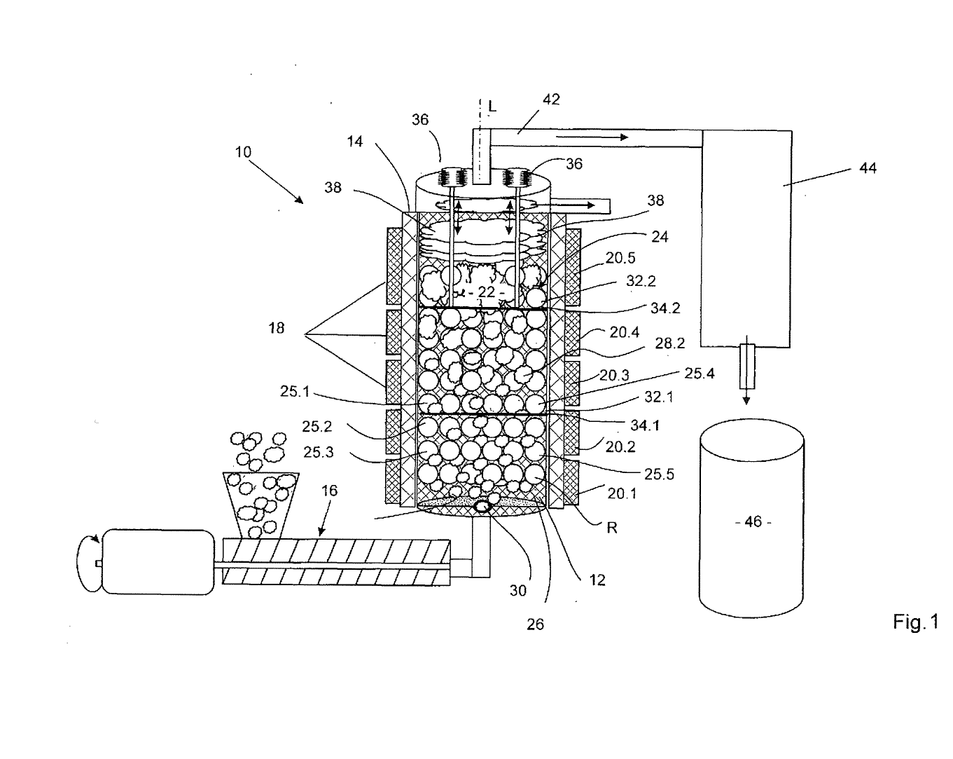

FIG. 1 a reactor according to the invention for carrying out a method according to the invention.

FIG. 1 shows a reactor 10 according to the invention for gasifying plastic material 12, in particular polyolefin polymers. The reactor comprises, for example, an essentially cylindrical reactor vessel 14 for heating the plastic material 12, which is introduced into the reactor vessel 14 via an extruder 16.

The reactor 10 comprises a heater 18 in the form of an inductive heater which has a number of coils 20.1, 20.2, . . . , 20.5 by means of which an alternating magnetic field is generated in an interior 22 of the reactor vessel 14. The coils 20 (references without a numerical suffix refer to the item as a whole) are connected to a power supply unit, not depicted here, which creates an alternating current in the coils. The frequency of the alternating current lies, for example, within a range from 25 to 50 kHz. Higher frequencies are possible, but they lead to an increase in the so-called skin effect, which is not desirable.

A deceleration device 24 is arranged in the interior 22 of the reactor vessel 14, by means of which the flow of liquefied plastic material 12 in the reactor vessel 14 can be decelerated. The deceleration device 24 comprises a plurality of movably arranged elements 25.1, 25.2, . . . , arranged in the interior 22 that are made up of steel balls in the present case. Due to their ferromagnetic properties, the elements 25 are heated by the inductive heating 18 and thereby heat a metal bath 26 in the reactor vessel 14.

The metal bath 26 has a maximum melting point of Tₘₑₗₜ=300° C. and is poured into the reactor vessel 14 to a filling level of H_{fill}. Along with the plastic material, it fills the gaps between the elements 25. For example, the metal bath should be made from Wood's metal, Lipowitz's alloy, Newton's metal, Lichtenberg's alloy and/or from an alloy that comprises gallium and indium. As a rule, the metal bath 26 has a density of more than 9 grams per cubic centimetre, thereby giving a lift to the plastic material 12. This lift accelerates the plastic material 12. The elements 25 counteract this acceleration.

Due to the temperature T in the reactor vessel 14 the plastic material 12 decomposes gradually, creating gas bubbles 28 in the process which rise upwards. The metal bath 26 can have a catalytic effect on the decomposition process, meaning that the reactor 10 can refer to a thermocatalytic depolymerization reactor. The supplied plastic material ends up in the interior 22 by moving through an entrance opening 30 that is preferably arranged on the base of the reactor vessel 14. The plastic material refers particularly to polyolefin.

The deceleration device 24 comprises restraint devices 32.1, 32.2, which comprise taut grids in frames 34.1, 34.2 in the present case, whose meshes are so small that the elements 25 cannot move upwards through them. The restraint device 32.2 is connected to a movement device 36 that comprises bars 38 running along a longitudinal axis L of the reactor vessel 14. The bars are fixed to eccentric motors, not depicted here, which are located on an upper side of the reactor vessel 14. In the present case the bars 28 are connected to the reactor vessel 14 by bellows. By means of these non-depicted eccentric motors, the rods 36 can be moved up and down, so that the restraint device 32 can also be moved up and down in an oscillating movement.

The distribution of the elements 25, which are balls in the present case, is shown purely schematically in FIG. 1. Due to its lift, they lie closely on each of the restraint devices 32 that are facing upwards; the density of balls is considerably smaller directly above a restraint device. In addition, in FIG. 1 the elements are marked in a constant radius R. However, it is particularly favorable if the radius R reduces as it moves upwards.

The reactor vessel 14 is constructed from a ferromagnetic material on the side facing the interior 22, for example from iron or magnetic steel. The induction heater 18 is designed in such a way that a temperature gradient occurs wherein the temperature rises with an increase in height. At the lower end of the reactor vessel 14, the temperature generally has an value of approximately T=300° C., whereas in the upper area, it is around T=450° C.

The reactor 10 has a pollutant remover 40, which is arranged at the upper end of the reactor vessel 14. As typical pollutants from plastic material, such as sand, are lighter than the metal bath, they float on top and can be removed from above. The reactor 10 also comprises a gas vent 42 that flows into a condenser 44 and any occurring gas is removed. Liquid material leaving the condenser 44 ends up in a collector 46.

### Reference Numerals List

10 Reactor
12 Plastic material
14 Reactor vessel
16 Extruder
18 Heater
20 Coil
22 Interior
24 Deceleration device
25 Element
26 Metal bath
28 Gas bubble
30 Entrance opening
32 Restraint device
34 Frame
36 Movement device
38 Bar
40 Pollutant remover
42 Gas vent
44 Condensor
46 Collector
Tₘₑₗₜ Melting temperature
T Temperature
L Longitudinal axis
R Ball radius
H_{fill} Filling level

1. A reactor for gasifying and/or cleaning, in particular for depolymerizing, plastic material with
(a) a reactor vessel for holding the plastic material, and
(b) a heater for heating the plastic material in the reactor vessel,
(c) the reactor vessel being at least partially filled with a metal bath,
characterized by
(d) a deceleration device arranged in an interior of the reactor vessel to decelerate a flow of liquefied plastic material in the reactor vessel,
(e) said deceleration device having a plurality of elements that are movably arranged in the interior.

2. The reactor according to claim 1, wherein the elements are made from ferromagnetic material.

3. The reactor according to claim 1, wherein the deceleration device is designed in such a way that it forces the liquefied plastic material onto a meandering path.

4. The reactor according to claim 1, wherein the heater is an inductive heater.

5. The reactor according to claim 1, characterized by at least one restraint device for the prevention of the flotation of the elements, in particular the balls.

6. The reactor according to claim 1, wherein at least one restraint device is connected to at least one movement device for moving the restraint device up and down.

7. The reactor claim 1, wherein the restraint device is connected to a motor, so that the restraint device can be moved in an oscillating movement, in particular along a longitudinal axis (L) of the reactor vessel.

8. The reactor according to claim 1, characterized by a plurality of restraint devices which can be automatically moved independently from each other in an oscillating movement, in particular along a longitudinal axis (L) of the reactor vessel.

9. A process for at least partially decomposing, in particular depolymerizing, and/or purifying plastic material characterized by the steps:
(a) introduction of the plastic material into a reactor vessel that is at least partially filled with a metal bath,
(b) heating of the plastic material by means of a heater, and
(c) deceleration of a flow of liquefied plastic material in the reactor vessel by means of a deceleration device arranged in an interior of the reactor vessel, which comprises a plurality of movable arranged elements.

10. The process according to claim 9, wherein the reactor is being operated in such a way that a ratio of the volume taken in by the elements and a reactor vessel volume of the reactor vessel has a value of at least 15% up to the filling level of the metal bath.
